(19) United States
(12) Patent Application Publication
(10) Pub. No.: US 2022/0266740 A1
(43) Pub. Date: Aug. 25, 2022

(54) RADAR MOUNTING STRUCTURE

(71) Applicant: HONDA MOTOR CO., LTD., Tokyo (JP)

(72) Inventors: Naoto INOUE, Tokyo (JP); Yoshiro TANAKA, Wako-shi (JP); Go SHIMIZU, Tokyo (JP); Ryoya KOBAYASHI, Tokyo (JP)

(21) Appl. No.: 17/671,823

(22) Filed: Feb. 15, 2022

(30) Foreign Application Priority Data
Feb. 22, 2021 (JP) 2021-026693

(51) Int. Cl. B60Q 1/00; G01S 13/931; G01S 7/02

(52) U.S. Cl. CPC B60Q 1/0023; G01S 13/931; G01S 7/027; G01S 2013/93277; G01S 2013/93271

(57) ABSTRACT

A radar mounting structure includes: a first light source; a second light source; a first light source lens covering the first light source; a second light source lens covering the second light source; a first housing that houses the first light source inside; a second housing that houses the second light source inside; and a radar configured to detect an object present ahead on a vehicle width direction outer side of a vehicle. The radar is attached to the first housing and is covered by the second light source lens.

### CROSS-REFERENCE TO RELATED APPLICATIONS

The present application claims the foreign priority benefit under Title 35 U.S.C. § 119 of Japanese Patent Application No. 2021-026693, filed on Feb. 22, 2021, in the Japan Patent Office, the disclosure of which is herein incorporated by reference in its entirety.

### BACKGROUND

### Technical Field

The present invention relates to a radar mounting structure of a radar mounted on a vehicle.

### Related Art

Conventionally, as an example of structure in which a radar is mounted on a vehicle, the vehicle lighting device disclosed in JP 2008-186741 A is known. The vehicle lighting device disclosed in JP 2008-186741 A has a lamp body constituted by a lamp body (10) and a front cover (20), in which lamp body a light source unit (30) and a millimeter wave radar (40) are provided.

In the lamp body, a light guide plate (60) that allows transmission of millimeter waves (R) emitted from the millimeter wave radar (40) is provided between the front cover (20) and the millimeter wave radar (40). The light guide plate (60) is caused to emit light using light emitted from the lamp (31), so as to downsize the lamp body.

The vehicle lighting device disclosed in JP 2008-186741 A is unitized by placing the millimeter wave radar (40), the light guide plate (60), and the light source unit (30) in the lamp body structure including the lamp body (10) and the front cover (20), to downsize the vehicle lighting device.

In the vehicle lighting device in JP 2008-186741 A, however, the light source unit (30) and the millimeter wave radar (40) are attached to the same lamp body (10). For this reason, in the event of replacing either the lamp (31) or the millimeter wave radar (40), the both have to be replaced, and thus the maintainability is low.

### SUMMARY

The present invention has been made in view of such circumstances, and it is an object of the present invention to provide a radar mounting structure by which the ease of maintenance of a radar and the appearance of a light source are improved.

To achieve the above-described object, a radar mounting structure of an embodiment according to the present invention includes: a first light source; a second light source; a first light source lens covering the first light source; a second light source lens covering the second light source; a first housing that houses the first light source inside; a second housing that houses the second light source inside; and a radar configured to detect an object present ahead on a vehicle width direction outer side of a vehicle. The radar is attached to the first housing and is covered by the second light source lens.

According to the present invention, it is possible to provide a radar mounting structure by which the ease of maintenance of a radar and the appearance of a light source are improved.

### BRIEF DESCRIPTION OF THE DRAWINGS

FIG. 1 is a perspective view illustrating a vehicle including a radar mounting structure according to an embodiment of the present invention.

FIG. 2 is a schematic perspective view illustrating the radar mounting structure.

FIG. 3 is a schematic front view illustrating the radar mounting structure.

FIG. 4 is an enlarged schematic cross-sectional view taken along line IV-IV of FIG. 3.

FIG. 5 is an enlarged schematic cross-sectional view taken along line V-V of FIG. 3.

### DETAILED DESCRIPTION

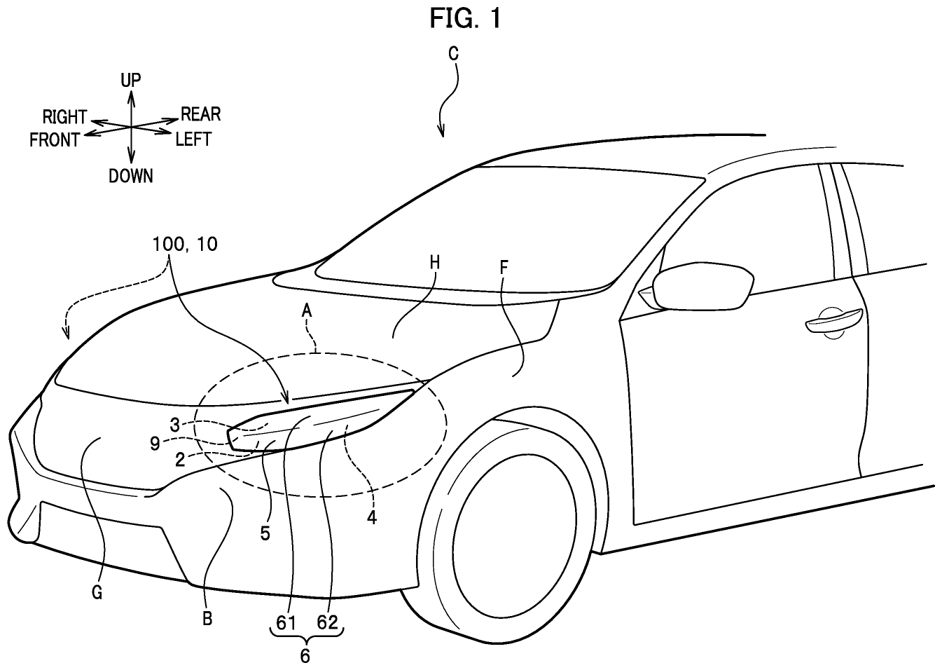

Referring to FIGS. 1 to 5, a radar mounting structure 100 of an embodiment according to the present invention will be described. In the embodiment, the same elements are denoted by the same reference numerals, and overlapping descriptions will be omitted.

Note that, in embodiments of the present invention, “front” means a front side of a vehicle C, “rear” means a rear side of the vehicle C, “up” means a vertically upper side, “down” means a vertically lower side, and “left-right” means a vehicle width direction of the vehicle C.

<Vehicle and Lighting Device>

First, before the radar mounting structure 100 of the embodiment according to the present invention is described, a vehicle C and a lighting device 10 to which the present invention is applied will be described.

As illustrated in FIG. 1, the vehicle C includes lighting devices 10 on the left and right in a front part of a vehicle body. The lighting device 10 includes a first light source 2 (for example, a headlamp), a second light source 3 (for example, a signal lamp(s)), and a radar 4. The lighting device 10 is disposed among a bonnet hood H, a bumper face B, a grille G, and a front fender F.

The vehicle C may be any automobile that includes the first light source 2, the second light source 3, and the radar 4, and its style or type is not particularly limited. Hereinafter, as an example of the vehicle C, a case of a passenger vehicle will be described as an example.

<Radar Mounting Structure>

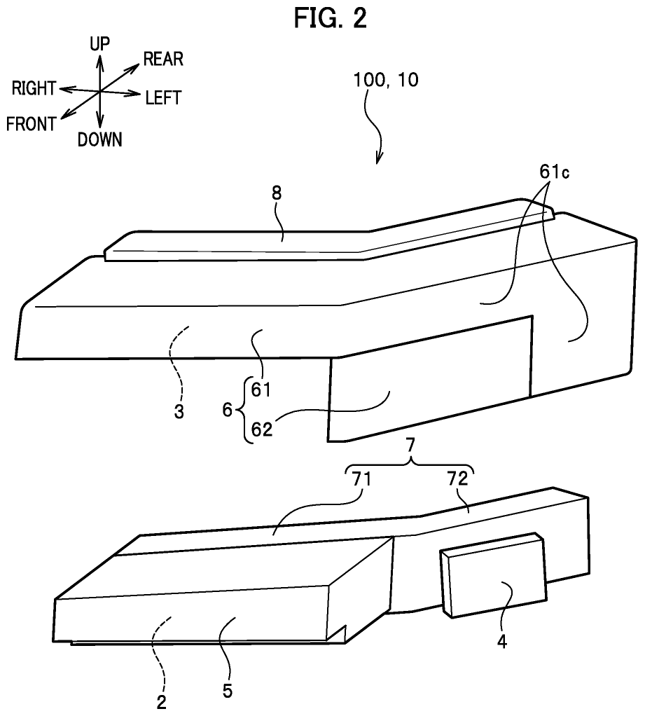

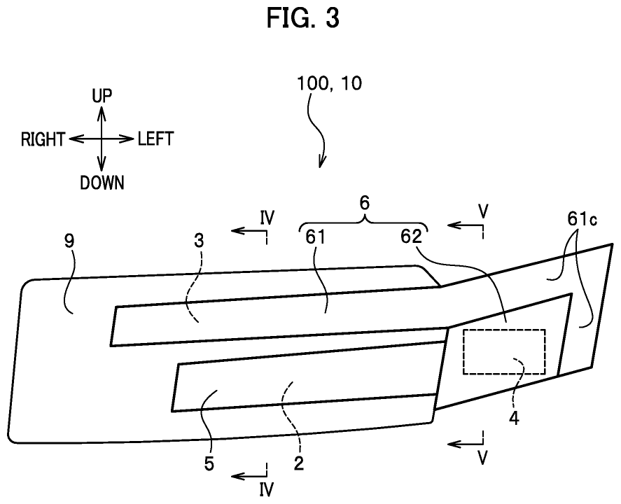

As illustrated in FIG. 2, the radar mounting structure 100 includes the first light source 2, the second light source 3, a first light source lens 5, a second light source lens 6, a first housing 7, a second housing 8, a garnish 9 (see FIG. 3), and the radar 4, in the front part of the vehicle body. As illustrated in FIG. 1, the radar mounting structures 100 are disposed symmetrically on the left and right in the front part of the vehicle C. Hereinafter, in the embodiment, the radar mounting structure 100 disposed on the left side in the front part of the vehicle C will be described, and the description of the right side will be omitted.

<First Light Source>

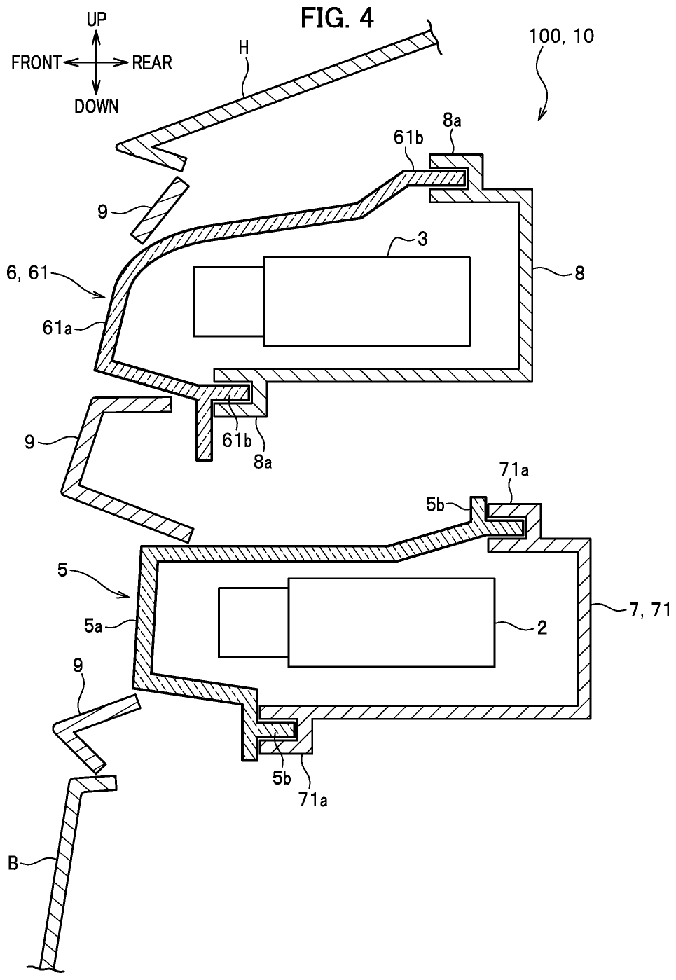

As illustrated in FIG. 4, the first light source 2 is, for example, a headlamp. The first light source 2 is attached to a first light source housing portion 71 of the first housing 7 disposed rearwardly of the first light source 2. The front side of the first light source 2 is covered by the first light source lens 5. The second light source 3 is installed above the first light source 2, and the first light source 2 and the second light source 3 are separate components.

<Second Light Source>

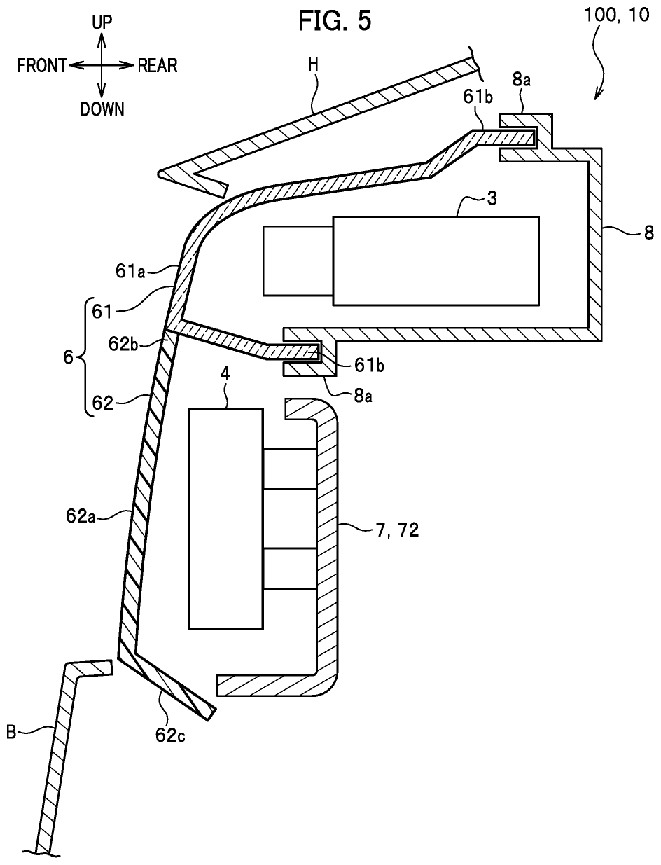

As illustrated in FIGS. 4 and 5, the second light source 3 is, for example, a signal lamp(s). Non-limiting examples of the signal lamps include a position lamp, a turn signal lamp, and the like. The second light source 3 (signal lamp(s)) is attached to the second housing 8 disposed rearwardly of the second light source 3. The front side of the second light source 3 is covered by a second light source cover portion 61 of the second light source lens 6. The second light source 3 has a longer length than the first light source 2 in the vehicle width direction. As illustrated in FIGS. 2, 3, and 5, the radar 4 is installed below a vehicle width direction outer portion of the second light source 3.

<Radar>

As illustrated in FIG. 5, the radar 4 is a sensor that detects an object present ahead on the vehicle width direction outer side of the vehicle C. As a specific example, the radar 4 is made up of, for example, a millimeter wave radar that detects an object by a reception unit receiving a radio wave that is emitted by a transmission unit (not illustrated) and reflected by the object. In addition, the radar 4 may be a sensor capable of detecting an object, such as a light detection and ranging (LiDAR) system, a camera, or an ultrasonic sensor. The radar 4 is attached to a radar housing portion 72 of the first housing 7 disposed rearwardly of the radar 4. The front side of the radar 4 is covered by a radar cover portion 62 of the second light source lens 6. As illustrated in FIG. 3, the first light source lens 5 is provided adjacent to a vehicle width direction inner side of the radar cover portion 62, which covers the radar 4.

<First Light Source Lens>

As illustrated in FIGS. 2 to 4, the first light source lens 5 serves as a lens cover (headlamp lens cover) disposed to cover the first light source 2 (headlamp). As illustrated in FIG. 4, the first light source lens 5 is formed integrally with a lens cover portion 5a provided in front of the first light source 2 and with a fixing portion 5b configured to fix the lens cover portion 5a to the first light source housing portion 71. The first light source lens 5 is formed of a transparent resin material such as an acrylic resin or a polycarbonate, which allows transmission of light emitted from the first light source 2. The first light source lens 5 has a shorter dimension in the vehicle width direction than the first housing 7 such that the first light source lens 5 covers only the first light source 2 and does not cover the radar 4.

The lens cover portion 5a serves as a lens that deflects light emitted from the first light source 2, in the forward direction, and also serves as a cover covering the front side of the first light source 2.

The fixing portion 5b is fixed to a coupling portion 71a formed on an outer peripheral portion of the first light source housing portion 71.

<Second Light Source Lens>

As illustrated in FIGS. 2 to 5, the second light source lens 6 serves as a lens cover (signal lamp lens cover) disposed to cover mainly the second light source 3 (signal lamp(s)). The second light source lens 6 is formed integrally with the second light source cover portion 61 (signal lamp lens cover portion) covering the second light source 3 and the radar cover portion 62 covering the radar 4, by two-color molding. The second light source lens 6 is formed of an opaque resin or the like, which allows transmission of light and millimeter waves emitted from the second light source 3 and the radar 4.

As illustrated in FIGS. 4 and 5, the second light source cover portion 61 is formed by integrally forming a lens cover portion 61a having a transverse U shape in a cross-sectional view and provided in front of the second light source 3, a fixing portion 61b configured to fix the lens cover portion 61a to the second housing 8, and an inverted L-shaped portion 61c (see FIGS. 2 and 3). As illustrated in FIG. 2, the second light source cover portion 61 extends from above the first light source lens 5 through an upper portion of the radar cover portion 62 to a left side portion of the radar cover portion 62.

As illustrated in FIGS. 4 and 5, the lens cover portion 61a serves as a lens that deflects light emitted from the second light source 3, in the forward direction, and also serves as a cover covering the front side of the second light source 3.

The fixing portion 61b is a portion to be inserted and fixed into a coupling portion 8a formed on an outer peripheral portion of the second housing 8. The fixing portion 61b is formed on an outer peripheral portion of the second light source cover portion 61.

The inverted L-shaped portion 61c (see FIGS. 2 and 3) is a portion formed in a substantially inverted L shape in a front view and located at a vehicle width direction outer end portion of the second light source cover portion 61.

As illustrated in FIG. 5, the radar cover portion 62 includes a cover portion 62a, a joining portion 62b, and a support portion 62c. An upper end portion and a left end portion of the radar cover portion 62 are joined and integrated with the inverted L-shaped portion 61c (see FIGS. 2 and 3). The first light source lens 5 and the garnish 9 (see FIG. 3) are provided at a right end portion of the radar cover portion 62.

The cover portion 62a is located in front of the radar 4 to cover the radar 4.

The joining portion 62b is a portion where the cover portion 62a is formed integrally with the lens cover portion 61a of the second light source cover portion 61 by two-color molding. The joining portion 62b is formed at an upper end portion and a vehicle width direction outer end portion of the cover portion 62a.

The support portion 62c is supported by the radar housing portion 72 of the first housing 7 and covers an outer peripheral portion of the radar housing portion 72. The support portion 62c is formed at a lower end portion of the radar cover portion 62.

<First Housing>

As illustrated in FIG. 2, the first housing 7 is a housing (headlamp housing) configured to house mainly the first light source 2 (see FIG. 4) inside the first housing 7. The first housing 7 is disposed rearwardly of the first light source 2 and the radar 4 and is made up of a member that holds the first light source 2 and the radar 4 from the rear side thereof. The first housing 7 includes the first light source housing portion 71 (see FIG. 4) and the radar housing portion 72 (see FIG. 5) formed integrally with the first light source housing portion 71. The first housing 7 is formed of an opaque resin member.

The first light source housing portion 71 holds the first light source 2 from the rear side thereof.

The radar housing portion 72 holds the radar 4. The radar housing portion 72 is formed extending continuously from a vehicle width direction outer end portion of the first light source housing portion 71 outward in the vehicle width direction. The first light source housing portion 71 and the radar housing portion 72 are provided below the second housing 8. The radar housing portion 72 is not covered by the first light source lens 5.

<Second Housing>

The second housing 8 is a housing (signal lamp housing) that houses the second light source 3 inside. The second housing 8 is a member that is disposed rearwardly of the second light source cover portion 61 disposed extending in the vehicle width direction and that is configured to hold the second light source 3 from the rear side thereof. The second housing 8 is formed of an opaque resin member.

<Garnish>

As illustrated in FIGS. 3 and 4, the garnish 9 is a decorative member that covers the first light source lens 5 and the second light source cover portion 61 of the second light source lens 6, from an upper side, a lower side, and a vehicle width direction inner side. The garnish 9 is disposed to cover an upper side, a lower side, and a vehicle width direction inner side of the first light source lens 5 and to cover an upper side, a lower side, and a vehicle width direction inner side of the second light source cover portion 61. The garnish 9 is formed of, for example, a transparent resin or an opaque resin.

<<Operations>>

The radar mounting structure 100 of an embodiment according to the present invention is basically configured as described above. Next, operations and effects of the radar mounting structure 100 will be described with reference to FIGS. 1 to 5.

As described above, the radar mounting structure 100 of the above-described embodiment according to the present invention includes, as illustrated in FIG. 2, FIG. 3, FIG. 4, and FIG. 5: the first light source 2, the second light source 3, the first light source lens 5 covering the first light source 2, the second light source lens 6 covering the second light source 3, the first housing 7 that houses the first light source 2 inside, the second housing 8 that houses the second light source 3 inside; and the radar 4 configured to detect an object that is present ahead on the vehicle width direction outer side of the vehicle C, in which the radar 4 is attached to the first housing 7 and is covered by the second light source lens 6.

According to such a configuration, the radar 4 is attached to the first housing 7 that houses the first light source 2 inside, so that a dedicated holding component is not necessary. Therefore, the number of component parts, the number of assembling person-hours, and the number of component parts management person-hours are reduced, leading to a reduction in the cost. In addition, the second light source lens 6, which covers the second light source 3, also serves as a radar cover covering the radar 4. Therefore, a cover dedicated to cover the radar is not necessary in the embodiment according to the present invention. Therefore, it is possible to reduce the number of component parts to improve the appearance of the light source, and it is possible to improve the accuracy of the attachment of the component parts.

In addition, the maintenance of the radar 4 and the second light source 3 can be conducted by simply detaching the second light source lens 6 or by simply detaching the assembly including the lens, the housing, and the second light source 3, so that the ease of maintenance at the time of replacing component parts can be improved and the maintenance work can be conducted in an efficient manner.

In addition, according to the radar mounting structure 100, in the lighting device 10 in which the first light source 2, the second light source 3, and the radar 4 are arranged in divided places, the radar cover (radar cover portion 62) covering the radar 4 is integrated with the cover covering the second light source 3 (second light source cover portion 61) to form the second light source lens 6. Therefore, as a fixing member or bracket for fixing the radar cover (the radar cover portion 62) is not necessary for the radar 4, it is possible to eliminate or avoid a member or a shape that obstructs radio waves and thus improve the radar performance.

In addition, as illustrated in FIGS. 3 and 4, an example of the first light source 2 is a headlamp, and an example of the second light source 3 is a signal lamp(s).

According to such a configuration, in general, when the headlamp, which is the first light source 2, is detached from the first housing 7 or from the first light source lens 5, so-called aiming for calibrating the orientation of the main optical axis in the light distribution characteristics is needed in order to cause the headlamp to operate correctly. This takes time and effort.

On the other hand, the radar 4 of the embodiment according to the present invention is covered by the second light source lens 6 covering the signal lamp(s), which is the second light source 3. Therefore, a maintenance can be conducted by simply detaching the cover (second light source lens 6) of the signal lamp(s) or by simply detaching the assembly including the lens, the housing, and the second light source 3. Therefore, in the event of conducting the maintenance of the radar 4, the radar 4 can be detached by simply detaching the signal lamp housing. Therefore, it is not necessary to detach the first light source lens 5 of the headlamp. Therefore, it is not necessary to conduct the aiming which is to be conducted in the event of detaching the headlamp, and thus the maintenance is facilitated.

Further, as illustrated in FIGS. 3 and 5, the second light source lens 6 is formed by two-color molding the second light source cover portion 61 covering the second light source 3 and the radar cover portion 62 covering the radar 4.

According to such a configuration, as the second light source cover portion 61 and the radar cover portion 62 are two-color molded in the second light source lens 6, the second light source cover portion 61 and the radar cover portion 62 can be integrally formed without a gap. Therefore, the embodiment according to the present invention makes it possible to reduce the likelihood of getting dirty due to clogging or contamination of water, dust, or the like in a gap between the second light source cover portion 61 and the radar cover portion 62. Furthermore, the lighting device 10 can be formed such that the boundary between the second light source cover portion 61 and the radar cover portion 62 cannot be visually recognized, leading to an improvement in the appearance of the lens cover.

In addition, the radar 4 is covered by the radar cover portion 62 and thus the radar 4 cannot be directly viewed. Therefore, the appearance can be improved.

### MODIFICATIONS

Heretofore, an embodiment according to the present invention have been described in detail with reference to the drawings. However, the present invention is not limited to the above-described embodiment, and can be appropriately modified without departing from the gist of the present invention.

For example, in the above-described embodiment, the first light source lens 5 and the second light source lens 6, illustrated in FIGS. 4 and 5, each have been described as being made of a resin as an example. However, any lens that allows transmission of light may be used. For example, a glass lens may be used.

In addition, the radar cover portion 62 may be provided integrally with the first light source lens 5. Also in this manner, it is possible to reduce the number of component parts, the number of assembling person-hours, and the number of component parts management person-hours and thus reduce the cost.

Further, in the above-described embodiment, the second light source lens 6, illustrated in FIGS. 3 and 5, has been described as being formed by two-color molding the second light source cover portion 61 covering the second light source 3 and the radar cover portion 62 covering the radar 4. Not only the lens covering the light source, but also the first light source lens 5 and/or the second light source lens 6 may be formed by two-color molding with a resin component part such as the garnish 9, the grille G, or the bumper face B.

According to such a configuration, it is possible to reduce the number of component parts and the number of assembling person-hours and improve the appearance.

What is claimed is:

1. A radar mounting structure comprising:
a first light source;
a second light source;
a first light source lens covering the first light source;
a second light source lens covering the second light source;
a first housing that houses the first light source inside;
a second housing that houses the second light source inside; and
a radar configured to detect an object present ahead on a vehicle width direction outer side of a vehicle,
wherein the radar is attached to the first housing and is covered by the second light source lens.

2. The radar mounting structure according to claim 1,
wherein the first light source comprises a headlamp, and
wherein the second light source comprises a signal lamp.

3. The radar mounting structure according to claim 1,
wherein the second light source lens is formed by two-color molding a second light source cover portion covering the second light source and a radar cover portion covering the radar.

4. The radar mounting structure according to claim 2,
wherein the second light source lens is formed by two-color molding a second light source cover portion covering the second light source and a radar cover portion covering the radar.
